(19) United States
(12) Patent Application Publication
(10) Pub. No.: US 2011/0143674 A1
(43) Pub. Date: Jun. 16, 2011

(54) METHOD FOR AVOIDING INTERFERENCE IN MOBILE COMMUNICATION SYSTEM

(75) Inventors: Kwang Jae Lim, Daejeon (KR); Chui Sik Yoon, Seoul (KR)

(73) Assignee: ELECTRONICS AND TELECOMMUNICATIONS RESEARCH INSTITUTE, DAEJEON (KR)

(21) Appl. No.: 13/058,703

(22) PCT Filed: Jun. 29, 2009
(86) PCT No.: PCT/KR2009/003510

§ 371 Date: Feb. 11, 2011

(30) Foreign Application Priority Data
Aug. 13, 2008 (KR) 1020080079289

(51) Int. Cl. H04B 15/00

(52) U.S. Cl. 455/63.1

(57) ABSTRACT

Provided is an interference avoiding method in a mobile communication system. A base station detects a preamble signal of another base station during an initial setting process or a time frame of a downlink transmission section to detect an adjacent interference base station or receive a report of information on the adjacent interference base station detected by a mobile station from the mobile station. When an adjacent interference base station is detected, the base station sets a common bandwidth from among the entire usage bandwidth as an interference avoiding bandwidth according to a defined rule. The base station allocates a subchannel in the interference avoiding bandwidth to a mobile station in a cell edge area adjacent to a cell of an interference base station.

### TECHNICAL FIELD

The present invention relates to an interference avoiding method in a mobile communication system.

### BACKGROUND ART

An interference avoiding bandwidth allocation method using a general fractional frequency reuse method increases the data rate and the QoS of a cell edge user by reducing interference from an adjacent cell or a sector for the user located on the cell edge. However, the interference avoiding method has the following problems.

First, cells and sectors must be appropriately arranged so as to use different cell edge bandwidths at neighboring sectors. However, since the actual wireless environment is not configured with hexagonal cells, it is difficult to dispose the cells.

Also, when the cell edge users are increased or decreased at the sector to thus increase or decrease the cell edge bandwidths, it is required to control the bandwidth between the sectors or control the bandwidth by using a control station through signaling with adjacent sectors through a backbone network in order to escape bandwidth superimposition.

Further, when several tens or several hundreds of femtocells are configured within a macrocell such as the femtocell or home base station, it is needed to dispose or control the cell edge bandwidth according to signaling through a backbone network between many femtocells and macrocells or between many femtocells.

In addition, since the cell disposal is changed as the base station moves when servicing a specific area according to a plurality of mobile base stations, it is impossible to predefine the cell edge bandwidth during the cell disposal process and it is needed to control the cell edge bandwidth according to frequent signaling between the mobile base stations. Also, when no signaling is allowable between the mobile base stations, it is impossible to apply the interference avoiding method for the cell edge user.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide an efficient interference avoiding method in a mobile communication system.

### Technical Solution

An exemplary embodiment of the present invention provides an interference avoiding method by a base station in a mobile communication system, including: detecting an adjacent interference base station; setting part of an entire usage bandwidth as an interference avoiding bandwidth when the adjacent interference base station is detected; and allocating a subchannel in the interference avoiding bandwidth to a cell edge mobile station with reference to a signal to interference-plus-noise ratio for each subchannel of the interference avoiding bandwidth.

### Advantageous Effects

According to an embodiment of the present invention, it is possible to reduce interference between adjacent base stations without signaling through a backbone network between the base stations or between the base station and the control station to thereby increase transmission efficiency and improve QoS for the user located on the cell edge

### BRIEF DESCRIPTION OF DRAWINGS

FIG. 1 shows interference avoidance bandwidth allocation using a fractional frequency reuse method in a general mobile communication system.

FIG. 2 shows a flowchart of an interference avoiding method in a mobile communication system according to an exemplary embodiment of the present invention.

FIG. 3 shows an interference avoiding bandwidth setting method according to an exemplary embodiment of the present invention.

FIG. 4 shows an interference avoiding method in a mobile communication system according to an exemplary embodiment of the present invention, exemplifying a cellular system configured with macrocells.

FIG. 5 shows an interference avoiding method in a mobile communication system according to another exemplary embodiment of the present invention, exemplifying a cellular system wherein a plurality of small femtocells are configured in a macrocell.

FIG. 6 shows an interference avoiding method in a mobile communication system according to another exemplary embodiment of the present invention, using the fractional frequency reuse method according to the conventional art and the interference avoiding method according to an exemplary embodiment of the present invention.

FIG. 7 shows an interference avoiding method in a mobile communication system according to another exemplary embodiment of the present invention, applying an interference avoiding method in a mobile base station.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a mobile station (MS) may indicate a terminal, a mobile terminal (MT), a subscriber station (SS), a portable subscriber station (PSS), user equipment (UE), and an access terminal (AT), and it may include entire or partial functions of the terminal, the mobile terminal, the subscriber station, the portable subscriber station, the user equipment, and the access terminal.

In the specification, a base station (BS) may indicate an access point (AP), a radio access station (RAS), a nodeB (Node-B), an evolved node-B (eNB), a base transceiver station (BTS), and a mobile multihop relay (MMR)-BS, and it may include entire or partial functions of the access point, the radio access station, the nodeB, the evolved node-B, the base transceiver station, and the mobile multihop relay-BS.

A conventional interference avoiding method will now be described in advance of an interference avoiding method in a mobile communication system according to an exemplary embodiment of the present invention.

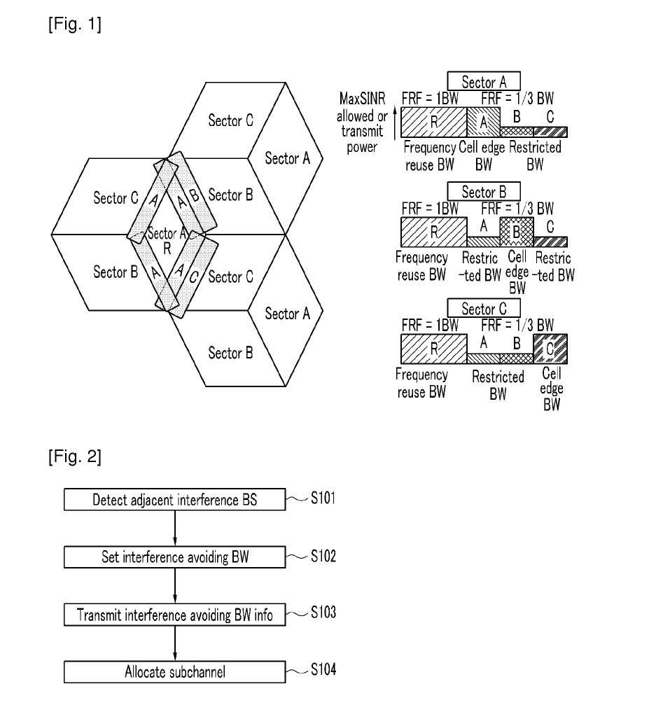

FIG. 1 shows interference avoidance bandwidth allocation using a fractional frequency reuse method in a general mobile communication system, exemplifying the case in which each cell is divided into three sectors to be serviced. In this case, the entire usage bandwidth (BW) used by the mobile communication system is exemplified to be divided into a bandwidth (cell inside bandwidth) with a frequency reuse factor of 1 for a cell inside user and a bandwidth (cell edge bandwidth) with a frequency reuse factor of ⅓ for a cell edge user.

Referring to FIG. 1, a user located inside the cell receives a radio resource (or a channel) of the cell inside bandwidth denoted as R, and this bandwidth has the frequency reuse factor (FRF) of 1 and is used for any cells or sectors without limits.

On the contrary, the user located on the cell edge uses part of the bandwidth corresponding to each sector from among the cell edge bandwidths denoted as A, B, and C. Heavy interference from adjacent sectors or cells occurs on the cell edge, and so each sector uses a different part of the bandwidth from among the cell edge bandwidth so as to avoid interference.

Referring to FIG. 1, the sector A of the cell located in the center uses the bandwidth A from among the cell edge bandwidth, and the sector B and the sector C adjacent to the sector A does not use the bandwidth A from among the cell edge bandwidth or uses the same with limited power in order to avoid interference with the sector A. Here, the bandwidth A becomes a cell edge bandwidth for the sector A, and it becomes a restricted bandwidth in the sector B and the sector C. In a like manner, the sector B uses the bandwidth B from among the cell edge bandwidth for the cell edge user, and the bandwidth B is not used or is used with restricted power in the sector A and the sector C so as to avoid interference with the sector B. That is, the bandwidth B becomes the cell edge bandwidth in the sector B and becomes the restricted bandwidth in the sector A and the sector C so that the sector A and the sector C for the bandwidth B generate no interference to the sector B or generate restricted interference to the same.

An interference avoiding method in a mobile communication system according to an exemplary embodiment of the present invention will be described in detail with reference to accompanying drawings.

A cell can be configured with one or a plurality of sectors, and hence a base station for controlling a cell can also control one or a plurality of sectors.

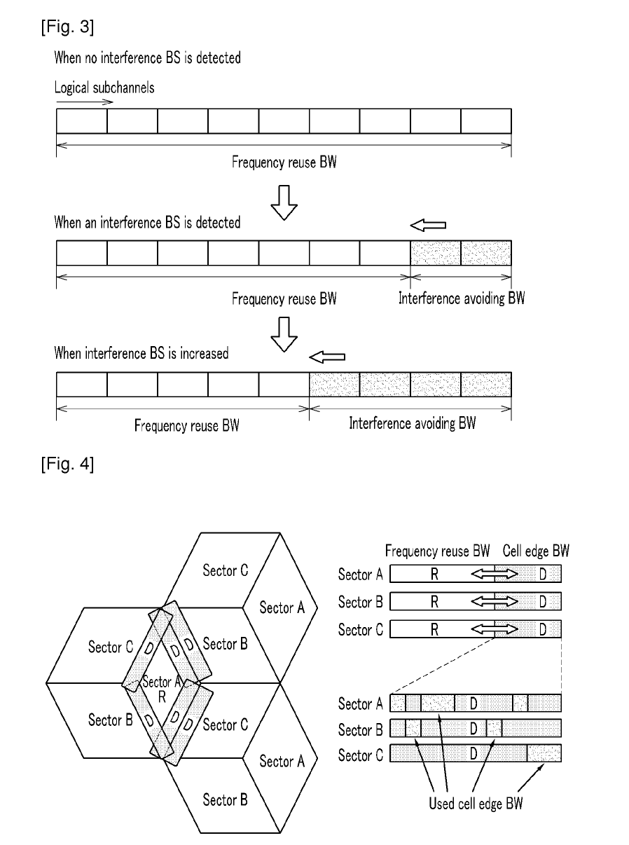

FIG. 2 shows a flowchart of an interference avoiding method in a mobile communication system according to an exemplary embodiment of the present invention. FIG. 3 shows an interference avoiding bandwidth setting method according to an exemplary embodiment of the present invention.

Referring to FIG. 2, the base station detects an adjacent interference base station (S101). The adjacent interference base station can be detected in many ways.

Regarding a first method, the base station detects a preamble or a pilot signal transmitted by another adjacent base station to detect the adjacent interference base station.

When using the first method, the base station performing an initial setting process after receiving power detects a preamble signal and a pilot signal of another base station before transmitting a signal in the downlink. On the contrary, a base station providing a service to the mobile station after performing the initial setting process periodically stops downlink signal transmission for a partial time interval of the downlink transmission section, and detects a preamble signal and a pilot signal of another base station.

Accordingly, the base station having detected the preamble signal and the pilot signal of the other base station determines the corresponding base station to be an adjacent interference base station when the received signal strength of the corresponding signal is greater than a threshold value.

Regarding the second method, the mobile station detects an adjacent interference base station, and reports it to the base station through a report message.

The mobile station attempts to detect a preamble or a pilot signal of a base station other than the service base station so as to search cells and perform a handoff. When the received signal strength of the detected preamble or pilot signal of the other base station is greater than the threshold value or when the carrier to interference-plus-noise ratio (CINR) of the detected preamble or pilot signal of the other base station is greater than the threshold value, the mobile station determines the corresponding other base station to be an adjacent interference base station. The mobile station transmits a report message for notifying existence of an adjacent interference base station to the service base station. Here, the service base station represents a base station for controlling the cell to which the mobile station belongs. Also, the report message includes a base station ID of the detected adjacent interference base station, received signal strength of the preamble signal, and CINR of the preamble signal, and notifies the base station of existence of the adjacent interference base station.

It is also possible in the exemplary embodiment of the present invention for the mobile station to detect a preamble or a pilot signal of another base station and detect an adjacent interference base station when the service base station request the mobile station to detect an adjacent interference base station as well as the method for the mobile station to detect a preamble or a pilot signal of another base station and detect an adjacent interference base station for the purpose of cell search and handoff. In this case, as described above, the mobile station transmits a report message including a base station ID of the detected adjacent interference base station, received signal strength of the preamble signal, and a CINR of the preamble signal to the service base station.

When the adjacent interference base station is detected, the base station sets part of the entire usage bandwidth as an interference avoiding bandwidth according to a predetermined rule (S102). Here, when there is an adjacent interference base station, all the base stations set an interference avoiding bandwidth to a common part of the entire usage bandwidth according to a common rule. That is, since there is no signaling between the base stations, the base stations set an interference avoiding bandwidth within the same predetermined bandwidth for the purpose of avoiding interference.

The size of the interference avoiding bandwidth depends on the number of adjacent interference base stations detected per base station, received signal strength of the preamble signal of the corresponding adjacent interference base station, and a CINR of the preamble signal. Therefore, the base station increases the size of the interference avoiding bandwidth when the number of the detected adjacent interference base stations is increased or the received signal strength of a preamble signal of the adjacent interference base station is increased, and the base station reduces the size of the interference avoiding bandwidth when the number of the adjacent interference base stations is reduced or signal strength of the adjacent interference base station is reduced. Since the CINR of the preamble signal of the adjacent interference base station can be temporally quickly changed by fading, when attempting to change the size of the interference avoiding bandwidth according to the CINR of the preamble signal of the adjacent interference base station, the average of the CINR of the preamble signal of the adjacent interference base station measured over several frames or several tens of frames is used. Therefore, increase or reduction of the interference avoiding bandwidth is performed over the time frame of several tens of frames.

FIG. 3 shows an example of setting an interference avoiding bandwidth wherein the entire usage bandwidth is divided into a plurality of logical subchannels. Also, the respective subchannels can be distributed subchannels including subcarriers distributed on the frequency axis or the time axis or localized subchannels including consecutive subcarriers. A method for configuring the subchannel is known to a person of ordinary skill in the art, and as such it will not be described.

Referring to FIG. 3, when there is no adjacent interference base station, the base station uses subchannels of the entire usage bandwidth without limits. However, when an adjacent interference base station is detected, the base station designates an interference avoiding bandwidth to a common part of the entire usage bandwidth. In the case of FIG. 3, the base station designates a predetermined number of subchannels as an interference avoiding bandwidth in the reverse order from the last subchannel from among the entire usage bandwidth. When the number of adjacent interference base stations is changed or the received signal strength of the preamble signal of the adjacent interference base station is changed to increase or decrease the size of the interference avoiding bandwidth, the base station further designates a predetermined number of subchannels as an interference avoiding bandwidth in the reverse order from the last subchannel that is not allocated as the interference avoiding bandwidth from among the entire usage bandwidth, or cancels a designated state of the interference avoiding bandwidth of a predetermined number of subchannels in the reverse order of the designation of the interference avoiding bandwidth.

Further, the method for allocating a predetermined number of subchannels as an interference avoiding bandwidth in the reverse order from the last subchannel from among the entire usage bandwidth is provided to describe the exemplary embodiment of the present invention, and it is possible in the present invention to designate part of another common bandwidth from among the entire usage bandwidth as an interference avoiding bandwidth.

Referring to FIG. 2 again, when the interference avoiding bandwidth is set, the base station transmits information on the interference avoiding bandwidth to the mobile station through a broadcasting message or a control channel (S103). Here, when the subchannel set as the interference avoiding bandwidth is a distributed subchannel, it is needed for the adjacent base station to use the same subchannel configuration in order to avoid interference.

When the interference avoiding bandwidth is set, the base station allocates a subchannel to the corresponding mobile station based on the CINR of the preamble signal generated by measuring the service base station by the mobile station serviced by the base station (S104). That is, the base station determines whether to allocate a subchannel within a non-interference avoiding bandwidth or a subchannel within the interference avoiding bandwidth to the mobile station based on the CINR of the preamble signal measured by the mobile station.

The serviced mobile station periodically measures the CINR of the preamble signal of the service base station and reports it to the service base station. When the mobile station serviced by the base station has a CINR of the preamble signal measured for the base station that is less than a threshold value, the base station determines that the corresponding mobile station is located in the cell edge area or an interference area, and allocates a subchannel within the interference avoiding bandwidth to the corresponding mobile station. On the contrary, when the CINR of the preamble signal is greater than the threshold value, the base station determines that the corresponding mobile station is located in the cell, and allocates a subchannel in the frequency reuse bandwidth, that is, the non-interference avoiding bandwidth with the frequency reuse factor of 1, to the corresponding mobile station. Below, a mobile station having received the subchannel in the interference avoiding bandwidth will be called a “cell edge mobile station”, and a mobile station having received the subchannel in the non-interference avoiding bandwidth will be referred to as a “cell inside mobile station.”

A method for allocating a subchannel in the interference avoiding bandwidth to a cell edge mobile station will now be described in detail.

The cell edge mobile station periodically measures the signal to interference-plus-noise ratio (SINR) on the subchannel in the interference avoiding bandwidth of the downlink and reports it to the service base station. Here, the SINR for the subchannel can be measured as a ratio between the received power of the preamble signal received with the same frequency as the subchannel from among the preamble signal of the service base station and interference and noise power of the signal received through the corresponding subchannel, or it can be measured as a ratio between the received power of the pilot signal received through the corresponding subchannel and the interference and noise power of the signal received through the corresponding subchannel. Accordingly, the SINR of the subchannel in the downlink interference avoiding bandwidth can be measured by the preamble signal transmitted by the base station or the pilot signal of the subchannel. However, since the mobile station does not transmit the signal through the corresponding subchannel in the case of the uplink, the mobile station transmits an uplink pilot signal or a sounding signal according to a request by the base station or periodically, irrespective of data transmission, so as to measure the SINR of the subchannel. The base station measures the uplink SINR of the respective subchannels by using the received uplink pilot signal or the sounding signal.

Accordingly, the base station having acquired the SINR of the subchannel in the interference avoiding bandwidth of the downlink and uplink sequentially allocates the subchannels starting from the subchannel with the greatest SINR from among the subchannels having the SINR greater than the threshold value for the downlink and uplink to the mobile station. This is because the subchannel having the SINR of less than the threshold value is used by the adjacent interference base station. In addition, the strength of the interference signal in the adjacent interference base station is changeable by time. Therefore, the base station uses a per-subchannel SINR that is temporally averaged over a plurality of frames so as to allocate the subchannel to the mobile station.

In order to escape a competitive power increase and an interference increase between the adjacent base stations in the interference avoiding bandwidth, the maximum transmission power that is usable by each subchannel or the allowable maximum received SINR is set to be inversely proportional to the SINR of the corresponding subchannel. That is, the base station determines that a subchannel with a large SINR is less interfered with by another cell, and allocates a subchannel of the interference avoiding bandwidth with reference to the maximum transmission power or the large allowable received SINR. However, the base station determines that the subchannel with a low SINR is greatly interfered with by another cell, and allocates a subchannel of the interference avoiding bandwidth with reference to the low maximum transmission power or the low allowable received SINR.

When the number of mobile stations in the cell or the load caused by the mobile station in the cell is increased and all the non-interference avoiding bandwidths are used, the base station can allocate a subchannel of the interference avoiding bandwidth for the mobile station in the cell. In this case, the maximum transmission power that is usable by the interference avoiding bandwidth or the maximum allowable received SINR is set to be proportional to the ratio of the channel gain for the service base station and the channel gain for the interference base station. That is, when the channel gain of the service base station is much greater than the channel gain of the interference base station, it corresponds to the case in which the corresponding mobile station is distant from the interference base station, and hence, the base station allocates a subchannel of the interference avoiding bandwidth to the mobile station with reference to the large maximum transmission power or the large allowable received SINR. However, when the channel gain of the service base station is less than the channel gain of the interference base station, it means that the corresponding mobile station is relatively adjacent to the interference base station, and hence, the base station allocates a subchannel of the interference avoiding bandwidth to the mobile station with reference to the low maximum transmission power or low allowable received SINR so as to reduce interference from the base station.

When a load of a specific base station is large or there are many mobile stations in the cell edge area of the corresponding base station, all the interference avoiding bandwidths can be occupied by the corresponding base station. In order to prevent this in the exemplary embodiment of the present invention, all the base stations having detected the adjacent interference base station control the usage rate of the interference avoiding bandwidth in their cells to be not greater than the threshold value.

Also, the base station selects some subchannels with a large SINR from among the interference avoiding bandwidth as an interference avoiding reservation bandwidth. In the case of the downlink, the base station transmits a pilot signal or a dummy data signal through the interference avoiding reservation bandwidth irrespective of usage states according to the actual data transmission, and in the case of the uplink, the base station requests the cell edge mobile station to transmit a pilot signal or a dummy data signal through the interference avoiding reservation bandwidth irrespective of usage states according to the actual data transmission. Here, the dummy data signal includes no actual data information, and it is transmitted in a predetermined signal format.

The base station selects some subchannels from among the subchannels with a large SINR as an interference avoiding reservation bandwidth for a predetermined time. Here, the subchannel selected as the interference avoiding reservation bandwidth can be changed by the change of the SINR of the subchannel, and since the base station selects the interference avoiding reservation bandwidth with reference to the SINR for each subchannel measured for a relatively long time of several tens of frames, the interference avoiding reservation bandwidth is not quickly changed.

As described, since the pilot signal or the dummy data signal is periodically or always transmitted through the interference avoiding reservation bandwidth in the exemplary embodiment of the present invention, when the adjacent interference base station measures the SINR of the corresponding subchannel, the SINR is measured as a low value because of the interference caused by the cell having selected the corresponding subchannel as the interference avoiding reservation bandwidth. Therefore, the adjacent interference base station escapes the usage at the corresponding subchannel.

FIG. 4 shows an interference avoiding method in a mobile communication system according to an exemplary embodiment of the present invention, exemplifying a cellular system configured with macrocells.

A method for setting and allocating an interference avoiding bandwidth with reference to the sector A located in the center of FIG. 4 will now be described.

Referring to FIG. 4, when the power is applied, the base station of the newly installed sector A detects an adjacent interference base station by detecting a preamble or a pilot signal of another base station before transmitting a signal to the downlink in the initial setting process. Further, when the adjacent interference base station is detected, the base station sets a common bandwidth from among the entire usage bandwidth that is some subchannels as an interference avoiding bandwidth. When the interference avoiding bandwidth is set, the base station of the sector A performs an initial setting process, transmits a preamble signal and a pilot signal to the downlink, and starts a service.

In order to detect the adjacent interference base station, the adjacent base stations being installed and providing a service periodically halts signal transmission in the downlink transmission section and detects a preamble or a pilot signal of another base station, or receives a report on information of the adjacent interference base station detected by the mobile station. Accordingly, the adjacent base stations having detected the adjacent interference base station sets a common bandwidth from among the entire usage bandwidth as an interference avoiding bandwidth according to a defined rule. Here, the interference avoiding bandwidth selected by the base station is located on the common bandwidth from among the entire usage bandwidth according to the predefined rule.

The base station selects the cell edge mobile station based on the CINR of the preamble signal for the base station provided by the mobile station, received signal strength of the preamble signal of the adjacent interference base station, and information on the CINR. The base station allocates some subchannels in the interference avoiding bandwidth to the mobile station based on the per-subchannel SINR included in the interference avoiding bandwidth reported by the cell edge mobile station, and provides the service through the corresponding subchannel. Here, since the base station uses the SINR of each subchannel included in the interference avoiding bandwidth as a reference when allocating the common interference avoiding bandwidth to the cell edge mobile station, respective cells can use different subchannels.

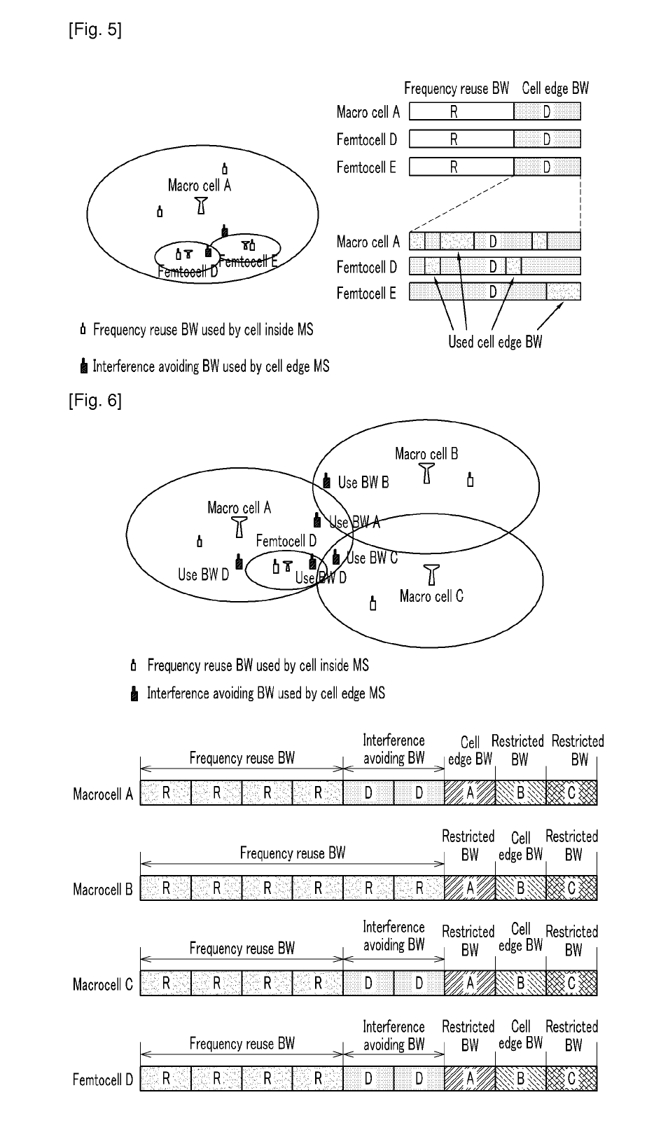

FIG. 5 shows an interference avoiding method in a mobile communication system according to another exemplary embodiment of the present invention, exemplifying a cellular system wherein a plurality of small femtocells are configured in the macrocell.

Referring to FIG. 5, the base station of the newly installed femtocell detects an adjacent interference base station by detecting a preamble or a pilot signal of another base station before transmitting a downlink signal. When the adjacent interference base station is detected, the base station sets a common bandwidth from among entire usage bandwidth as an interference avoiding bandwidth according to a defined rule. When the interference avoiding bandwidth is set, an installation process according to the femtocell installation process is performed, and the base station of the femtocell starts the service by transmitting a preamble signal and a pilot signal to the downlink.

The base station of the adjacent femtocell previously installed in addition to the newly installed femtocell periodically stops signal transmission in the downlink transmission section, and attempts to detect a preamble signal or a pilot signal of another base station so as to detect an adjacent interference base station. Further, the base station can receive a report of information on the detected adjacent interference base station from the mobile station. In the case of the macrocell in which it is difficult to temporarily stop signal transmission in the downlink transmission section, it is possible to detect the adjacent interference base station through a report message of the mobile station.

The base station of the femtocell or the macrocell at which an adjacent interference base station is detected sets an interference avoiding bandwidth in a predetermined common bandwidth from among the entire usage bandwidth according to a defined rule. Here, the interference avoiding bandwidths selected by all adjacent base stations are the same.

The base station of the femtocell or macrocell having set the interference avoiding bandwidth determines a cell edge mobile station with reference to the CINR of the preamble signal of the base station reported by the mobile station and the received signal strength and the CINR of the interference base station. The base station allocates a subchannel of the interference avoiding bandwidth to the cell edge mobile station and provides a service thereto. The base station allocates the subchannel to the cell edge mobile station in the common interference avoiding bandwidth with reference to the SINR of each subchannel so that each cell can use different subchannels.

FIG. 6 shows an interference avoiding method in a mobile communication system according to another exemplary embodiment of the present invention, using the fractional frequency reuse method according to the conventional art and the interference avoiding method according to an exemplary embodiment of the present invention.

In FIG. 6, the fractional frequency reuse method according to the conventional art is applied between macrocells, and the interference avoiding method according to the exemplary embodiment of the present invention is applied between the macrocell and the femtocell or between the femtocells.

Referring to FIG. 6, macrocells A, B, and C are adjacent to each other, and a femtocell D is located in the macrocell A.

The subchannel established in the cell disposal process is used according to the existing fractional frequency reuse method on the cell edge among the macrocells A, B, and C. For example, the base station of the macrocell A allocates a subchannel in the bandwidth A to the mobile station belonging to the macrocell A and being interfered by the macrocell B or the macrocell C, and does not use or restrictedly uses the bandwidth A in the macrocell B and the macrocell C. In a like manner, the base station of the macrocell C allocates a subchannel in the bandwidth C to the mobile station belonging to the macrocell C and being interfered with by the macrocell A or the macrocell B, and does not use or restrictedly uses the bandwidth C in the macrocells A and B.

In the initial setting process, the base station of the femtocell D can detect a preamble or a pilot signal of another base station to detect an adjacent interference base station that is the macrocells A and C before transmitting a downlink signal. Also, the base station of the femtocell D periodically detects a preamble or a pilot signal of another base station in a section of a downlink transmission section to detect an adjacent interference base station that is the macrocells A and C or receives a report in which the macrocells A and C are detected as an adjacent interference base station from the mobile station.

When an adjacent interference base station is detected, the base station of the femtocell D sets a common bandwidth from among the entire usage bandwidth, that is, the bandwidth D, as an interference avoiding bandwidth according to a defined rule. When the mobile station belonging to the macrocell is located on the cell edge with the femtocell D or the mobile station belonging to the femtocell D is located on the cell edge with the macrocell, the base station allocates a subchannel in the bandwidth D to the corresponding mobile station. Therefore, the corresponding mobile station can use a service through the subchannel of the bandwidth D. Here, the base station of the femtocell D allocates the subchannel with the greatest SINR that is the subchannel with the least interference from among the interference avoiding bandwidth to the cell edge mobile station to avoid inter-cell interference.

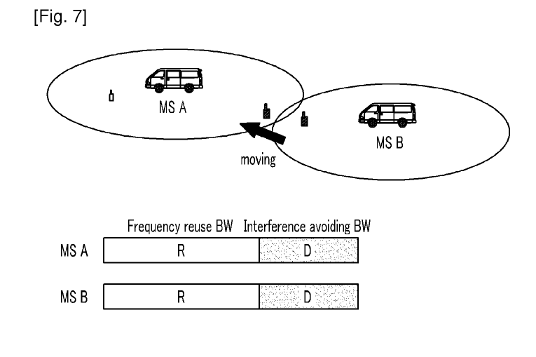

FIG. 7 shows an interference avoiding method in a mobile communication system according to another exemplary embodiment of the present invention, applying an interference avoiding method in a mobile base station.

Referring to FIG. 7, the mobile base station B is adjacent to the mobile base station A. The mobile base station periodically stops transmitting a signal to part of the downlink section and detects a preamble signal of another base station to detect an adjacent interference base station, or receives information on the adjacent interference base station detected by the mobile station. Therefore, as the mobile base station B approaches the mobile base station A, the mobile base station B can be detected as an adjacent interference base station of the mobile base station A, and the mobile base station A can be detected as an adjacent interference base station of the mobile base station B.

When an adjacent interference base station is detected, the mobile base station sets an interference avoiding bandwidth to a common bandwidth from among the entire usage bandwidth according to a defined rule. The mobile base station allocates a subchannel in the interference avoiding bandwidth to the mobile station in the cell edge area near the cell of the adjacent interference base station.

As described above, the interference avoiding method according to the exemplary embodiment of the present invention reduces interference with the neighboring base station without signaling between base stations or between the base station and the control station through a backbone network, thereby increasing transmission efficiency. Particularly, the QoS of the user located on the cell edge is improved.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An interference avoiding method by a base station in a mobile communication system, comprising: detecting an adjacent interference base station; setting part of an entire usage bandwidth as an interference avoiding bandwidth when the adjacent interference base station is detected; and allocating a subchannel in the interference avoiding bandwidth to a cell edge mobile station with reference to a signal to interference-plus-noise ratio for each subchannel of the interference avoiding bandwidth.

2. The interference avoiding method of claim 1, wherein the detecting includes: detecting a preamble signal and a pilot signal of another base station before transmitting a downlink signal during an initial setting process; and determining the other base station as the adjacent interference base station when received signal strength of the detected preamble signal and the pilot signal of the other base station is greater than a threshold value.

3. The interference avoiding method of claim 1, wherein the detecting includes: periodically stopping signal transmission for a time frame of the downlink transmission section, and detecting a preamble signal and a pilot signal of another base station; and determining the other base station as the adjacent interference base station when received signal strength of the detected preamble signal and the pilot signal of the other base station is greater than a threshold value.

4. The interference avoiding method of claim 1, wherein the detecting includes the base station receiving a report message including a base station ID of the adjacent interference base station, received signal strength of a preamble signal, and a carrier to interference-plus-noise ratio of the preamble signal from a mobile station for providing a service, and the mobile station periodically detects a preamble signal and a pilot signal of another base station, and determines the other base station as the adjacent interference base station when received signal strength of the detected preamble signal and pilot signal of the other base station is greater than a threshold value.

5. The interference avoiding method of claim 1, wherein the setting includes determining a size of the interference avoiding bandwidth with reference to a number of the detected adjacent interference base stations, received signal strength of a preamble signal of the adjacent interference base station, and a carrier to interference-plus-noise ratio.

6. The interference avoiding method of claim 5, wherein the allocating includes: the base station receiving a report on a carrier to interference-plus-noise ratio of a preamble signal for the base station from a mobile station providing a service; determining the mobile station to be the cell edge mobile station when the carrier to interference-plus-noise ratio of the preamble signal for the base station is less than the threshold value; and determining the mobile station to be a cell inside mobile station when the carrier to interference-plus-noise ratio of the preamble signal for the base station is greater than the threshold value.

7. The interference avoiding method of claim 6, wherein the allocating further includes: acquiring a signal to interference-plus-noise ratio for each subchannel in the interference avoiding bandwidth; and allocating the subchannels to the cell edge mobile station in the order from the subchannel with the great signal to interference-plus-noise ratio.

8. The interference avoiding method of claim 7, wherein the acquiring includes: periodically receiving a signal to interference-plus-noise ratio for each subchannel in the interference avoiding bandwidth from the cell edge mobile station in the case of a downlink; and measuring a signal to interference-plus-noise ratio for each subchannel in the interference avoiding bandwidth by using a pilot signal and a sounding signal provided by the cell edge mobile station in the case of an uplink, and the cell edge mobile station measures the signal to interference-plus-noise ratio by using received power of a preamble signal with the same frequency for each subchannel and an interference and noise power ratio of a signal received through the corresponding subchannel.

9. The interference avoiding method of claim 7, wherein allocating to the cell edge mobile station includes setting the maximum transmission power that is usable by a subchannel in the interference avoiding bandwidth and the allowable maximum received signal to interference-plus-noise ratio in inverse proportion to the signal to interference-plus-noise ratio for each subchannel in the interference avoiding bandwidth.

10. The interference avoiding method of claim 1, further including the base station controlling a use factor of the interference avoiding bandwidth in the cell to not be greater than the threshold value.

11. The interference avoiding method of claim 1, further including: selecting a subchannel from among the interference avoiding bandwidth as an interference avoiding reservation bandwidth based on a signal to interference-plus-noise ratio; transmitting a pilot signal or a dummy data signal through the interference avoiding reservation bandwidth in the case of a downlink; and requesting the mobile station to transmit a pilot signal or a dummy data signal through the interference avoiding reservation bandwidth in the case of an uplink.

12. The interference avoiding method of claim 1, further including allocating a subchannel in the interference avoiding bandwidth to the mobile station in the cell inside area when non-interference avoiding bandwidths other than the interference avoiding bandwidth are used.

13. The interference avoiding method of claim 12, wherein the allocating a subchannel in the interference avoiding bandwidth to the mobile station in the cell inside area includes the mobile station in the cell inside area setting the maximum transmission power usable by a subchannel in the interference avoiding bandwidth and the allowable maximum received signal to interference-plus-noise ratio in proportion to the ratio of the channel gain for the base station and the channel gain for the interference base station near the base station.
